(19) United States
(12) Patent Application Publication
(10) Pub. No.: US 2008/0136130 A1
(43) Pub. Date: Jun. 12, 2008

(54) PORTABLE HOUSE KEEPING SYSTEM

(76) Inventor: Kanethia Washington, Chicago, IL (US)

Correspondence Address: BLACK LOWE & GRAHAM, PLLC, 701 FIFTH AVENUE, SUITE 4800, SEATTLE, WA, 98104, US

(21) Appl. No.: 11/749,025

(22) Filed: May 15, 2007

Related U.S. Application Data
(60) Provisional application No. 60/747,252, filed on May 15, 2006.

(51) Int. Cl. B62B 1/00

(52) U.S. Cl. 280/47.17

(57) ABSTRACT

A housekeeping system for holding and transporting supplies, such as cleaning supplies, in a variety of environments includes an interior compartment. By way of example, the housekeeping system may be a portable unit used by a room attendant to clean hotel rooms. The interior may include dividers and a removable caddy system configured to hold room supplies, cleaning supplies, room amenities, products, and other items. Uniquely configured pockets may be located on the system to hold specialized tools or utensils. For example, a pocket may be located on the side of the system for holding a toilet brush and closable to substantially a brush portion of the toilet brush. Preferably, the portable housekeeping system is sized and configured for maneuverability into and out of doorways and around furniture.

### PRIORITY CLAIM

The present application claims priority from U.S. Provisional Application No. 60/747,252 filed on May 15, 2006 entitled MOBILE-PACK under Attorney Docket No. BPTR-1-1001 and which is herein incorporated by reference in its entirety.

### FIELD OF THE INVENTION

The present invention relates generally to portable housekeeping systems and methods, such as systems and methods for cleaning one or more guest rooms in a hotel.

### BACKGROUND OF THE INVENTION

Conventional cleaning carts, such as the carts used in the hotel industry, have remained substantially unchanged for decades. One primary purpose of the conventional cleaning carts is to hold as many room supplies (e.g., towels, tissue, blankets, pillows, glasses, etc.) as possible while simultaneously holding a variety of cleaning supplies (chemical cleaners, glass cleaners, deodorizers, garbage bags, sponges, etc.). The conventional cleaning carts are generally sized and configured to hold as many items so as to limit the number of trips back and forth by attendants to linen closets or other designated storage areas for room supplies, cleaning supplies, or other items needed to completely clean a certain number of rooms in the hotel.

### SUMMARY OF THE INVENTION

In one example of the invention, a portable housekeeping system for transporting supplies includes a lid, a base, and a plurality of sidewalls. The sidewalls are joined with the base and the lid to form at least one interior compartment. A plurality of dividers are located in the interior compartment and arranged to form sub-compartments between the respective dividers. And, a removable caddy system having a caddy base and a plurality of caddy compartments is sized to be received in the interior compartment. The caddy base of the removable caddy system is supported by at least one of the plurality of dividers.

In another example of the invention, a portable housekeeping system for transporting supplies includes a lid, a base, and a plurality of sidewalls. The sidewalls are joined with the base and the lid to form at least one interior compartment. In addition, the system includes a pocket coupled to an exterior portion of one of the sidewalls. The pocket is sized to receive a cleaning utensil having a brush portion coupled to an elongated handle portion. By way of example, the cleaning utensil may be a toilet brush. The pocket is closable to substantially conceal the brush portion of the utensil.

In yet another example of the invention, a method of using a portable housekeeping system includes loading a plurality of supplies in the housekeeping system. The housekeeping system includes a body having at least one interior compartment. The body is mounted on wheels and rollingly maneuverable with an extended handle. The body includes an exterior made from a flexible, fabric material. The method further includes transporting the portable housekeeping system through a doorway of a room by using the handle to roll the system through the door on the wheels. Next, the method includes that once inside the room, the supplies that were previously loaded in the housekeeping system may be used to at least clean the room.

### BRIEF DESCRIPTION OF THE DRAWINGS

The preferred and alternative embodiments of the present invention are described in detail below with reference to the following drawings:

FIG. 1 is an isometric view of a portable housekeeping system according to an embodiment of the invention;

FIG. 2 is an isometric view of an interior compartment of the portable housekeeping system of FIG. 1;

FIG. 3 is front elevational view of a portable housekeeping system according to another embodiment of the invention;

FIG. 4 is a rear elevational view of a telescoping handle coupled to the portable housekeeping system of FIG. 3 according to an embodiment of the invention; and

FIG. 5 is a flowchart of a method of using a portable housekeeping system according to an embodiment of the invention.

### DETAILED DESCRIPTION OF THE PREFERRED EMBODIMENT

In the following description, certain specific details are set forth in order to provide a thorough understanding of various embodiments of the invention. In other instances, well-known structures and methods associated with cleaning housekeeping devices, assemblies, and systems may not be shown or described in detail to avoid unnecessarily obscuring descriptions of the embodiments of the invention.

The following description relates generally to a housekeeping system for holding and transporting supplies, such as cleaning supplies, in a variety of environments. By way of example, the housekeeping system may be a portable unit used by a room attendant to clean hotel rooms. In this example, the housekeeping system may be configured to hold room supplies, cleaning supplies, room amenities, products, and possibly other items or objects and yet be sized for maneuverability into and out of doorways and around furniture.

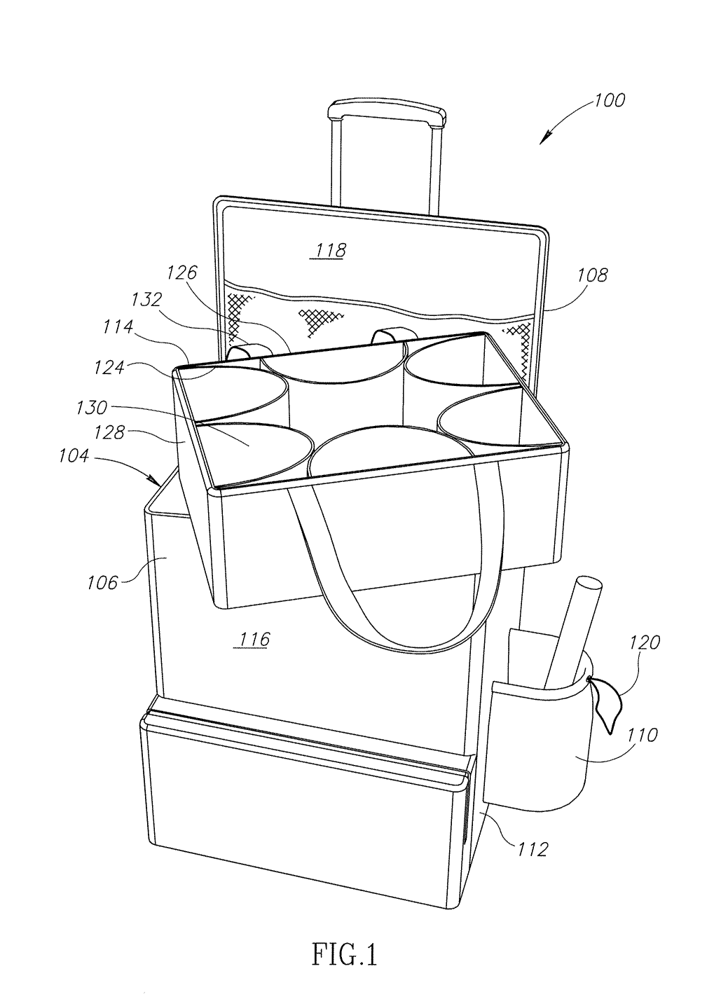

FIG. 1 shows a housekeeping system 100 for holding supplies 102 according to another illustrated embodiment. The housekeeping system 100 is sized and configured to fit into and out of doorways and around items, such as furniture. In a preferred embodiment, the housekeeping system 100 includes at least one interior compartment 104 encompassed within a plurality of sidewalls 106, a lid 108, and a first side pocket 110. The housekeeping system 100 may further include a front compartment 112 and a removable caddy system 114.

An exterior material 116 used for the housekeeping system 100 may be a plastic or other synthetic material. In the preferred embodiment, the exterior material 116 is a woven nylon material coated with polyethylene for water resistance. By way of example, the exterior material 116 may be a material commonly referred to as ballistic nylon. Used in a variety of applications, ballistic nylon is a relatively thick, tough, synthetic nylon fabric. The term ballistic nylon was coined during World War II for a type of material that was intended to protect soldiers and airmen from flying debris and shrapnel impacts. Some of the more common applications employing ballistic nylon are the manufacture of luggage, back packs, tool belts, and motorcycle jackets.

In the preferred embodiment, an interior material 118 is a polyester fabric that is easily cleanable with a damp rag. Both the exterior and interior materials 116, 118 are durable. Other materials may be used as desired to provide a desired amount of durability, rigidity and aesthetic quality.

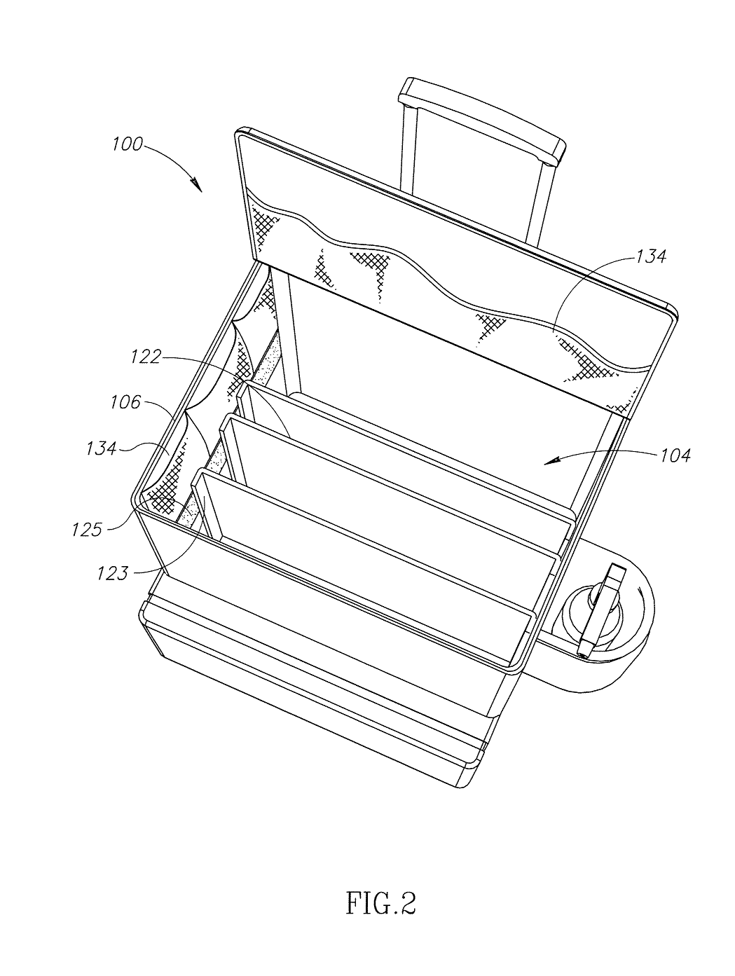

Referring briefly to FIG. 2, the interior compartment 104 includes dividers 122 coupled to the sidewalls 106 of the housekeeping system 100. The dividers 122 may be either fixedly or removably coupled to the sidewalls 106. For example, the dividers 122 may include end portions 123 lined with a hook and loop fastener material, for example a VELCRO® brand fastener, for adjustably engaging a hook and loop fastener strip 125 coupled to the interior compartment 104. In one embodiment, the dividers 122 are made from polyethylene sheet or board and covered with a polyester fabric. The dividers 122 may be arranged within the interior compartment 104 to form sub-compartments. Further, the dividers 122 may support the removable caddy system 114 (FIG. 1). The number of dividers 122 may be altered to advantageously change the size of the sub-compartments.

Referring back to FIG. 1, the lid 108 is a reinforced lid that includes a sheet or board encased in a fabric material. In the preferred embodiment, the lid 108 includes a polyethylene board encased or otherwise sewn into in ballistic nylon. The lid 108, when open, may be retained in the open position with a strap (not shown). When closed, the lid 108 may be retained in the closed position with a zipper, buttons, or some equivalent closure device. In addition, the lid 108 may include a locking mechanism for securing the lid 108 in the closed position. In one embodiment, the locking mechanism is a padlock which is extendable through zipper eyelets, such as a padlock used on an item of luggage. The ability to lock the housekeeping system 100 advantageously allows the attendant the assurance of knowing that items stocked in the system 100 at the end of each day will be available and ready to use the following work day.

The first side pocket 110 comprises a receptacle or container received within a closable fabric pocket. The pocket 110 is sized to receive a head of a toilet brush. Preferably, the receptacle is made from a durable and easy to clean plastic material, for example polyvinylchloride (PVC). Additionally or alternatively, removable and replaceable plastic liners may be used to line the receptacle, line the fabric pocket, or both. In one embodiment, the pocket 110 includes a drawstring 120 that allows the pocket 110 to be closed. The drawstring 120 utilizes the fabric material of the pocket to cover up the head of the toilet and thus advantageously keeps the head of the toilet brush out of plain sight when the toilet brush is not being used, for example when the attendant is moving the system 100 from one room to the next.

The removable caddy system 114 includes fabric dividers 124 coupled to caddy sidewalls 126 and a bottom panel 128. The sidewalls 126 and the bottom panel 128 are made from a polyethylene sheet or board covered with a polyester fabric material. Preferably, the fabric dividers 124 are arranged to create sub-pockets or sub-compartments 130 within the caddy system 114. The sub-compartments 130 are used to hold small items. In the preferred embodiment, the caddy system 114 may take the form of a removable tray having a plurality of dividers forming internal compartments. For example, there may be six compartments with nylon fabric dividers that are arranged to form one large center compartment as shown in the illustrated embodiment. In operation, the removable caddy system 114 may be removed from the housekeeping system 100 with straps 132. The caddy system 114 may contain all the supplies, products, and amenities to clean and replenish a desired room, for example a bathroom within a hotel room.

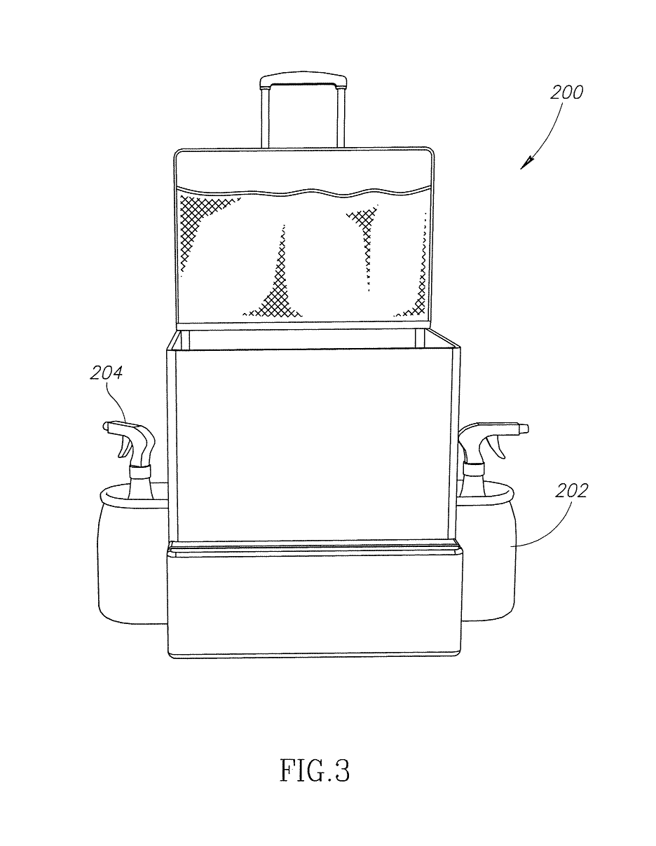

FIG. 3 shows another embodiment of a housekeeping system 200 that includes a majority of the features described above. This embodiment includes a number of second pockets 202. In one embodiment, the number of second pockets 202 includes three pockets located around a back of the system 200 and two pockets located on each respective side of the system 200. The number of second pockets 202 may vary depending on how the system 200 is to be utilized. For example, one embodiment may include the system 200 without any second pockets 202. Preferably, the second pockets are sized and configured to hold bottles, containers, or other types of receptacles 204 that may contain some type of cleaning solution, which may be in fluid or solid form.

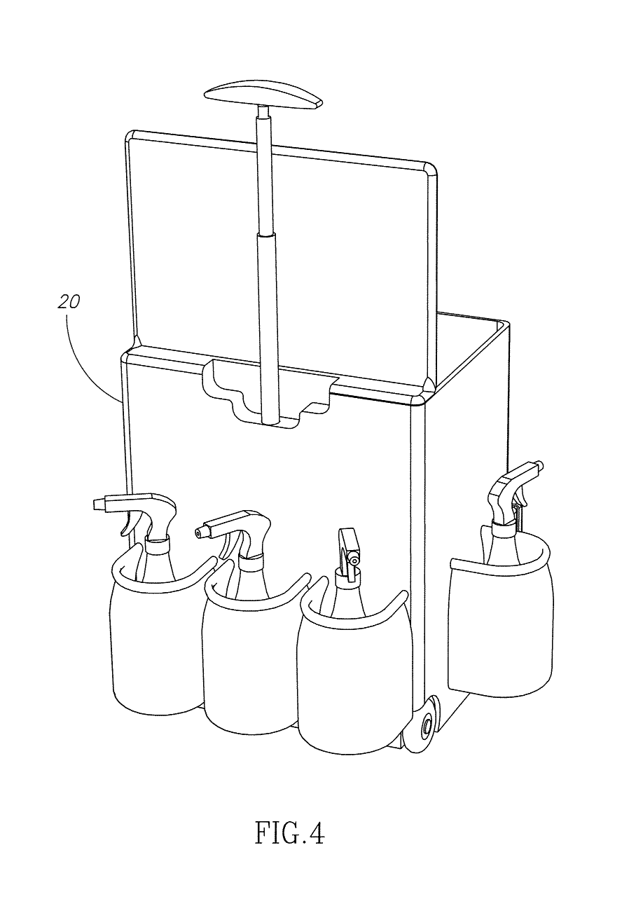

FIG. 4 shows a housekeeping system 300 having a handle 302 that includes a grippable portion 304 and a telescopic portion 306. In the preferred embodiment, the handle 302 is an adjustable, telescopic handle that can be adjusted to account for a height of an attendant sing the housekeeping system 300. The telescopic portion 206 may include a single, telescoping rod as shown in the illustrated embodiment or alternatively may include more than one telescoping rod (FIG. 1). In another embodiment, the handle 302 is adjustable by other than telescoping means or may be located in a fixed position.

In addition to the above-described embodiments, those embodiments may include additional features such as wheels, a nametag holder, and nylon mesh compartments. In one embodiment, the wheels are similar to the type of wheels used for roller blades. By way of example, the wheels may be approximately four inch diameter wheels coupled to a base of the housekeeping system. To move the housekeeping system, the attendant only needs to telescope the handle, lean it towards them and pull the system as it is supported on the wheels. Two or more wheels may be used to support the housekeeping system.

The nametag holder permits the attendant to place identifying information, such as a business card in the nametag holder. The identifying information operates to ensure that others know who owns or has control of the system and prevents one attendant from confusing their system with the system of another attendant. In the preferred embodiment, the nametag holder is located on a top, exterior surface of the lid.

Lastly, the housekeeping system may include one or more nylon mesh compartments or pockets 134 (FIG. 2) configured to hold additional supplies. The nylon mesh compartments 134 may be clipped or otherwise attached to interior or exterior portions of the housekeeping system. In one embodiment, the mesh compartments 134 are attached to an interior portion of the lid and to interior portions of the sidewalls 106 (FIG. 2).

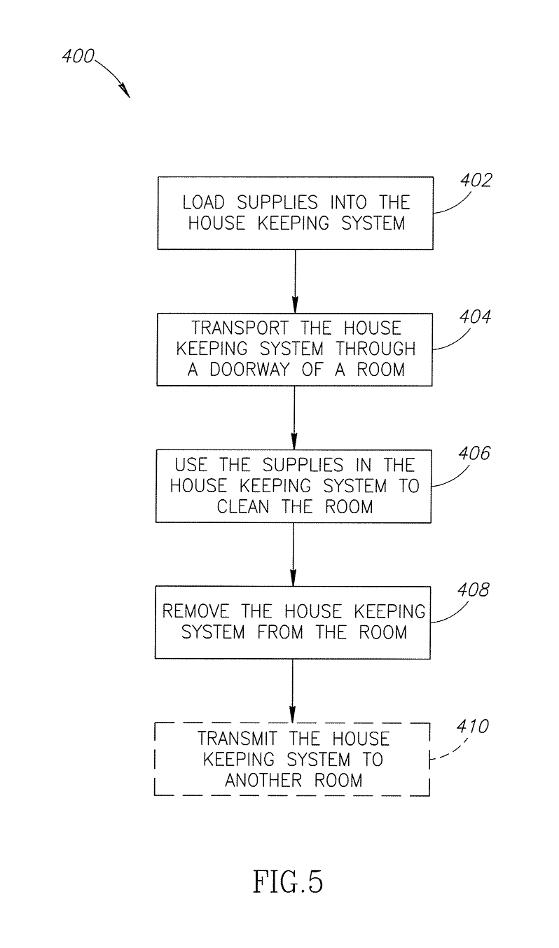

In operation, FIG. 5 shows a method 400 of using a portable housekeeping system to clean a room. At step 402, supplies are loaded into the housekeeping system. The supplies may include, but are not limited to, cleaning products and utensils, replacement products or items, and other items that may typically be found in a hotel guest room. The housekeeping system includes a body having at least one interior compartment. The body is mounted on wheels and is maneuverable with an extended, telescoping handle. The body includes an exterior made from a flexible, fabric material, which minimizes damage to walls and doorway jams, and which minimizes noise when bumping into the walls or door way jams. Loading the supplies includes loading them into pockets attached to the exterior of the system, into mesh pockets attached to an interior compartment of the system, in between dividers located in the interior compartment, and into a removable caddy system. In one embodiment, the removable caddy system is supported on top of the dividers and is located within the interior compartment.

At step 404, the portable housekeeping system is transported through a doorway of a room, such as a hotel guest room by using the handle to roll the system on its wheels. At step 406, and once the attendant is inside the room, the supplies may used to at least clean the room and in many cases also to restock the room with items such as shampoo, conditioner, garbage bag liners, etc. At step 408, the portable housekeeping system is removed from the room, most likely through the same doorway in which the system entered the room. At step 410, the attendant may optionally transport the portable housekeeping system to another room if there is another room to be cleaned and if there are sufficient supplies remaining in the portable housekeeping system.

In addition to the above, another aspect of using the portable housekeeping system to clean the room includes removing a removable caddy system from the interior compartment and carrying the caddy system to another portion of the room that is located a distance from a physical location of the portable housekeeping system. By way of example, the caddy system may be removed from the interior compartment by using handles coupled to the caddy system to lift it out of the interior compartment. While leaving the housekeeping system in place, the caddy system may then be carried to the bathroom of the hotel guest room. Accordingly, the caddy system would include enough bathroom supplies, products, and items to completely clean and restock the bathroom.

These and other changes can be made in light of the above detailed description. In general, in the following claims, the terms used should not be construed to limit the invention to the specific embodiments disclosed in the specification and the claims, but should be construed to include all types of housekeeping systems and methods of using the same that operate in accordance with the claims.

While the preferred embodiment of the invention has been illustrated and described, as noted above, many changes can be made without departing from the spirit and scope of the invention. For example, various types of materials, storage features or components, handles, wheels, and compartment sizes may be arranged to achieve similar or slightly different objectives and advantages than those described above. Accordingly, the scope of the invention is not limited by the disclosure of the preferred embodiment. Instead, the invention should be determined by reference to the claims that follow.

1. A portable housekeeping system for transporting supplies, the housekeeping system: comprising:
a lid;
a base;
a plurality of sidewalls joined with the base and the lid to form at least one interior compartment;
a plurality of dividers located in the interior compartment and arranged to form sub-compartments between the respective dividers; and
a removable caddy system having a caddy base and a plurality of caddy compartments, the removable caddy system sized to be received in the interior compartment, wherein the caddy base is supported by at least one of the plurality of dividers.

2. The housekeeping system of claim 1, further comprising a pair of wheels coupled to the base.

3. The housekeeping system of claim 1, wherein the lid, the base and the sidewalls each include a polyethylene board covered with a polyester fabric material.

4. The housekeeping system of claim 1, further comprising a side pocket configured to hold a cleaning fluid container, the side pocket coupled to one of the plurality of sidewalls.

5. The housekeeping system of claim 1, wherein the plurality of dividers each include a polyethylene board covered with a polyester fabric material.

6. The housekeeping system of claim 1, wherein the removable caddy system includes handles for lifting the caddy system from the interior compartment.

7. The housekeeping system of claim 1, wherein the caddy base includes a polyethylene board covered with a polyester fabric material.

8. The housekeeping system of claim 1, further comprising a telescoping handle coupled to the housekeeping system.

9. The housekeeping system of claim 1, further comprising a second pocket coupled to an exterior portion of a sidewall of the housekeeping system, the second pocket sized to receive a cleaning utensil having a brush portion coupled to an elongated handle, wherein the second pocket, after receiving the cleaning utensil, is closable to substantially maintain the brush portion from plain sight.

10. A portable housekeeping system for transporting supplies, the housekeeping system comprising:
a lid;
a base;
a plurality of sidewalls joined with the base and the lid to form at least one interior compartment; and
a pocket coupled to an exterior portion of one of the sidewalls, the pocket sized to receive a cleaning utensil having a brush portion coupled to an elongated handle portion, wherein the pocket, after receiving the cleaning utensil, is closable to substantially conceal the brush portion of the utensil.

11. The housekeeping system of claim 10, further comprising a plurality of dividers located in the interior compartment and arranged to form sub-compartments between the respective dividers.

12. The housekeeping system of claim 11, further comprising a removable caddy system having a caddy base and a plurality of caddy compartments, the removable caddy system sized to be received in the interior compartment, wherein the caddy base is supported by at least one of the plurality of dividers.

13. The housekeeping system of claim 10 wherein the cleaning utensil is a toilet brush.

14. The housekeeping system of claim 10 wherein the pocket includes a drawstring coupled to an upper portion of the pocket to make the pocket closable for substantially concealing the brush portion of the utensil.

15. A method of using a portable housekeeping system, the method comprising:
loading a plurality of cleaning supplies in the housekeeping system that includes a body having at least one interior compartment, the body being mounted on wheels and maneuverable with an extendable handle, the body further having an exterior made from a flexible fabric material;
transporting the portable housekeeping system through a doorway of a room by using the handle to roll the system through the door on the wheels; and
once inside the room, using the supplies loaded in the housekeeping system to clean the room.

16. The method of claim 15, wherein loading the plurality of supplies includes loading the plurality of supplies into a removable caddy system located in the at least one interior compartment.

17. The method of claim 16, further comprising:
removing the caddy system from the interior compartment; and
transporting the caddy system to a portion of the room away from a physical location of the portable housekeeping system.

18. A method of transporting supplies with a portable housekeeping system, the method comprising:
loading a plurality of cleaning supplies in at least an interior compartment of the housekeeping system;
moving the portable housekeeping system through a doorway of a room; and
removing a caddy system from the interior compartment, wherein removing the caddy system includes carrying the caddy system to another portion of the room that is located a distance from a physical location of the portable housekeeping system.

19. The method of claim 18, wherein carrying the caddy system to another portion of the room includes carrying the caddy system from a sleeping area of a hotel guest room into a bathroom of the hotel guest room.

20. The method of claim 18, wherein removing the caddy system from the interior compartment includes grasping at least one handle coupled to the caddy system to life the caddy system out of the interior compartment.
